(19) United States
(12) Patent Application Publication
(10) Pub. No.: US 2013/0168297 A1
(43) Pub. Date: Jul. 4, 2013

(54) SCREENING SYSTEM FOR BIOMASS PROCESSING SYSTEM

(71) Applicant: Mark G. Lyman, Salem, OR (US)

(72) Inventor: Mark G. Lyman, Salem, OR (US)

(21) Appl. No.: 13/614,979

(22) Filed: Sep. 13, 2012

Related U.S. Application Data
(60) Provisional application No. 61/534,567, filed on Sep. 14, 2011.

(51) Int. Cl. B07B 9/00

(52) U.S. Cl. CPC B07B 9/00
USPC 209/234

(57) ABSTRACT

A screening assembly for separating components of a material includes at least one roll screener with a plurality of roll elements that are spaced apart from each other generally in a first direction to define a plurality of first openings therebetween. The roll elements are operable to rotate to separate the material into a first component and second component. The first component is conveyed generally in the first direction, and the second component moves away from the first component through the first openings. Furthermore, the screening assembly includes at least one vibrational screener with a vibrating member that defines a plurality of second openings. The vibrating member is operable to receive the second component and to vibrate to separate the second component into a first sub-component and a second sub-component. The second sub-component moves away from the first sub-component through the second openings.

### CROSS-REFERENCE TO RELATED APPLICATIONS

This application claims the benefit of U.S. Provisional Application No. 61/534,567, filed on Sep. 14, 2011. The entire disclosure of the above application is incorporated herein by reference.

### FIELD

The present disclosure relates to biomass processing systems and, more particularly, to a screening system for a biomass processing system.

### BACKGROUND

This section provides background information related to the present disclosure which is not necessarily prior art.

Biomass, such as corn stover (i.e., stalks, leaves, and other portions of the corn plant other than the ear of corn), plant waste, tree waste, other biological material, etc. can be used to make ethanol or other products. Biomass is typically gathered and compressed into bales to facilitate storage and transport. However, the bale of biomass material must usually be broken down into small pieces, shredded, cleaned, or otherwise processed before the biomass material may be used for its desired purposes. These steps are typically performed manually, which can be labor intensive and inefficient.

Also, in some cases, the biomass bales can include components of many sizes. For instance, the bale can include larger components (e.g., stalks, leaves, etc.) and smaller components (e.g., plant fibers, dust, etc.). These components may need to be separated so that downstream processing of the biomass can completed in an effective manner. Also, it may be necessary to remove dust, dirt, and/or debris from the biomass before the biomass is further chopped, chemically treated, or otherwise processed downstream.

### SUMMARY

This section provides a general summary of the disclosure, and is not a comprehensive disclosure of its full scope or all of its features.

A screening assembly for separating components of a material is disclosed. The screening assembly includes at least one roll screener with a plurality of roll elements that are spaced apart from each other generally in a first direction to define a plurality of first openings therebetween. The roll elements are operable to rotate to separate the material into a first component and second component. The first component is conveyed generally in the first direction, and the second component moves away from the first component through the first openings. Furthermore, the screening assembly includes at least one vibrational screener with a vibrating member that defines a plurality of second openings. The vibrating member is operable to receive the second component and to vibrate to separate the second component into a first sub-component and a second sub-component. The second sub-component moves away from the first sub-component through the second openings.

Also, a screening assembly for separating components of a material is disclosed. The screening assembly includes a first roll screener with a plurality of roll elements that are spaced apart from each other generally in a first direction to define a plurality of first openings therebetween. The roll elements are operable to rotate to separate the material into a first component and second component. The first component is conveyed generally in the first direction, and the second component moves away from the first component through the first openings. The screening assembly also includes a secondary screener that defines a plurality of second openings. The secondary screener is disposed underneath the first openings such that the secondary screener is operable to receive the second component falling through the first openings due to gravity. The secondary screener is operable to receive the second component and to separate the second component into a first sub-component and a second sub-component. The second sub-component moves away from the first sub-component through the second openings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic elevational view of a screening system for screening and separating components of biomass according to exemplary embodiments of the present disclosure;

FIG. 2 is a perspective view of the screening system of FIG. 1; and

FIG. 3 is a side schematic view of the screening system according to additional embodiments.

Corresponding reference numerals indicate corresponding parts throughout the several views of the drawings.

### DETAILED DESCRIPTION

Example embodiments will now be described more fully with reference to the accompanying drawings.

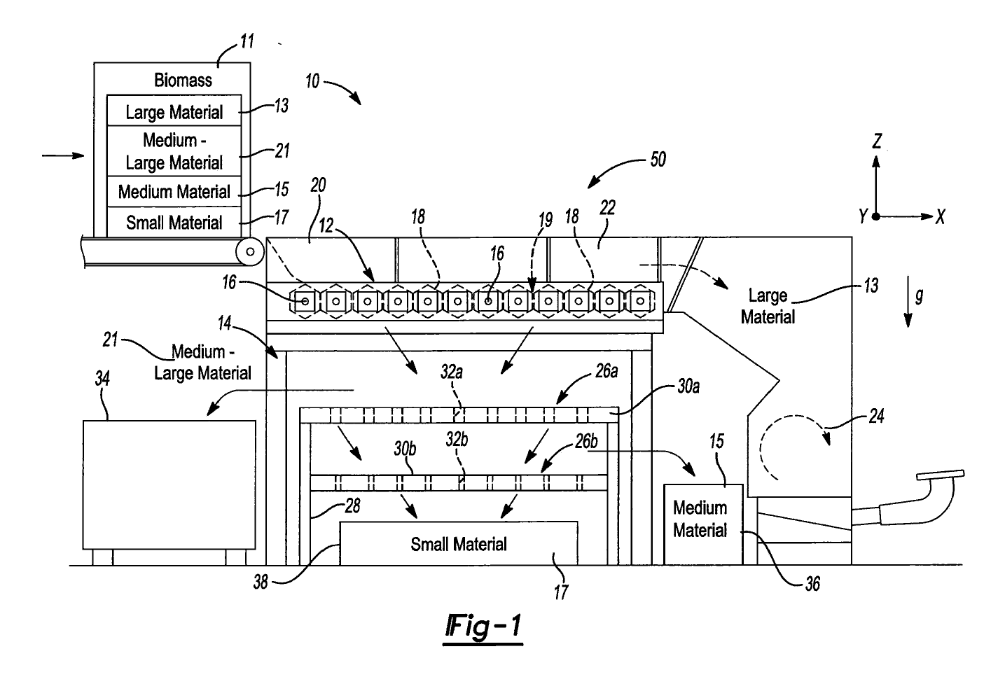

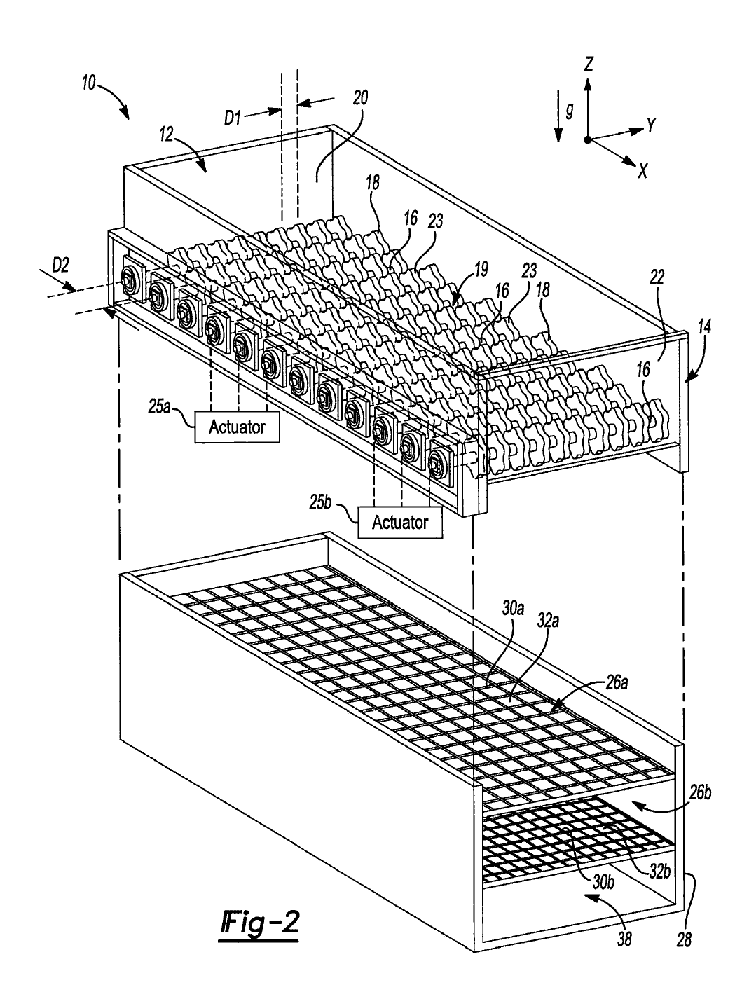

Referring initially to FIGS. 1 and 2, a screening assembly 10 is illustrated according to exemplary embodiments of the present disclosure. As will be discussed in detail, the screening assembly 10 is operable to receive an amount of biomass 11 (corn stover, stalks, leaves, and other portions of the corn plant other than the ear of corn, plant waste, tree waste, other biological material, etc.) or other material and separate it into separate components 13, 15, 17, 21.

The screening assembly 10 can be included in a continuous material process, wherein the biomass 11 is delivered in a bale or other compacted state. The bale of biomass 11 can be de-strung or otherwise unbound. Then, the bale can be roughly chopped by a chopper or otherwise unpacked and delivered to the screening assembly 10. Next, the screening assembly 10 can separate biomass 11 into the separate components 13, 15, 17, 21 based on the respective size of the components 13, 15, 17, 21. Once separated and screened, one or more of the components 13, 15, 17, 21 can be individually delivered to a shredder for further size reduction, can be delivered to a chemical treatment process (e.g., to make ethanol, etc.), can be discarded, or can be delivered to another downstream processing station. In some embodiments, the screening assembly 10 can be part of the processes disclosed in Applicant's co-pending U.S. patent 1pplication Ser. No. 13/540,412, filed Jul. 2, 2012, which is hereby incorporated by reference in its entirety. It will be appreciated, however, that the screening assembly 10 can be part of a stand-alone process of separating the biomass 11 or other material into separate components 13, 15, 17, 21.

As shown in FIG. 1, the biomass 11 can include relatively large components 13 (e.g., sections of corn stalk, etc.), medium-to-large components 21 (e.g., leaves, etc.), medium-sized components 15 (e.g., stray fibers, etc.), and small materials (e.g., dust, dirt, etc.). In some embodiments, the screening assembly 10 separates and screens these components 13, 15, 17, 21 based on size. For instance, the large components 13 and/or medium-to-large components 21 may need to be shredded and made smaller before further processing, while the medium material 15 can be small enough for immediate downstream processing. Also, the small material 17 (e.g., dirt and dust) may need to be separated and discarded completely so that these small materials 17 do not negatively effect subsequent processing.

It will be appreciated that the screening assembly 10 could be configured to screen and separate any number of components 13, 15, 17, 21 of any size from each other. (These components 13, 15, 17, 21 can be referred to as components, sub-components, sub-sub-components, etc. of the biomass 11 depending on which portion of the screening assembly 10 is performing screening as will become apparent.)

It will also be appreciated that the screening assembly 10 could be used to screen any material other than biomass 11 without departing from the scope of the present disclosure. Likewise, although the illustrated embodiments of the screening assembly 10 is used to separate the components 13, 15, 17, 21 based on the relative size of the components 13, 15, 17, 21, the screening assembly 10 could be configured to separate the components 13, 15, 17, 21 based on the relative shape of the components 13, 15, 17, 21, based on material differences of the components 13, 15, 17, 21, or based on another criteria.

As shown in FIGS. 1 and 2, the screening assembly 10 can include at least one roll screener 12 (i.e., a first roll screener) and at least one vibrational screener 26a, 26b (i.e., a secondary screener). The illustrated embodiments of FIGS. 1 and 2 include one roll screener 12 and two vibrational screeners 26a, 26b ; however, there can be any number of roll screeners 12 and any number of vibrational screeners 26a, 26b.

The roll screener 12 can include a support structure 14. The support structure 14 can include a plurality of rigid beams, plates, bars, or other support elements that collectively have high strength and durability. The support structure 14 can define an upstream end 20 of the roll screener 12, which can receive the biomass 11 via a belt conveyor, a crane, etc. The support structure 14 can also define a downstream end 22, which can deliver at least part of the biomass 11 to a collector 24.

The roll screener 12 can also include a plurality of axles 16. Each axle 16 can be elongate and longitudinally straight. In the embodiments illustrated, the axles 16 each have a circular cross section. Each of the axles 16 can be rotatably supported by the support structure 14. Specifically, as shown in FIG. 2, the axles 16 can each be substantially parallel to a Y-axis (e.g., a horizontal axis that is perpendicular to the direction (vector) of gravity, g). Also, the axles 16 can be arranged in a row and spaced apart at a distance D2 (FIG. 2) along an X-axis direction (the downstream direction). The distance D2 can be equal between each pair of axles 16, or the distance D2 can vary between different adjacent pairs of axles 16. As will be discussed, the axles 16 can be driven in rotation about their respective longitudinal axis (i.e., the respective axis of rotation) relative to the support structure 14. For instance, the axles 16 can each extend through opposing upright walls of the support structure 14 and can be rotatably attached to the support structure 14 by respective bearings, etc.

Moreover, the roll screener 12 can include a plurality of roll elements 18. As shown in FIG. 2, the roll elements 18 can each comprise a flat, rigid disc that has an outer peripheral surface 23 (e.g., outer diameter surface). The roll elements 18 can be approximately equally sized and similarly shaped in some embodiments, or the roll elements 18 can have different sizes and shapes.

Each axle 16 can include one or more roll elements 18 fixed or otherwise attached thereto, and the roll elements 18 can be spaced apart from each other on the respective axle 16 at a distance D1 (FIG. 2). The roll elements 18 of one axle 16 can be disposed partially between roll elements 18 of another axle 16 in some embodiments. Otherwise, the space D2 between the axles 16 can be large enough to further separate the roll elements 18 in the X-direction. Regardless, the roll elements 18 can be spaced apart from each other in the X-direction (by the space D2) and/or in the Y-direction (by the space D1) to define a plurality of first openings 19 between the roll elements 18.

In some embodiments, the spacing D1 between the roll elements 18 along each axle 16 can be substantially equal for the entire roll screener 12. In other embodiments, the spacing D1 can vary across one or more axles 16 and/or across the roll screener 12. Likewise, the spacing D2 between the axles 16 can be substantially equal across the roll screener 12, or the spacing D2 can vary across the roll screener 12. As a result, the first openings 19 can have substantially equal size (e.g., in the X-Y plane), or the first openings 19 can vary in size across the roll screener 12. For instance, in some embodiments, the first openings 19 can get progressively larger moving from the upstream end 20 to the downstream end 22. Also, in some embodiments, the roll elements 18 can be removably mounted to the respective axles 16 and the spacing D1 of the roll elements 18 can be selectively changed, and/or the axles 16 can be removably mounted to the support structure 14 and the spacing D2 can be selectively changed to thereby selectively configure the size of the first openings 19.

The outer peripheral surface 23 of one or more of the roll elements 18 can vary in radius as the surface 23 extends about the respective axis of rotation. For instance, in the embodiments illustrated, the surface 23 can be smoothly contoured so as to include a plurality of alternating concave and convex surfaces. However, the surface 23 can have a constant radius, can include a jagged or toothed profile, etc.

As shown in FIG. 2, the roll screener 12 can further include one or more actuators 25a, 25b. The actuators 25a, 25b can be an electric motor, a hydraulic or pneumatic actuator, or other driving mechanism. The actuators 25a, 25b can be operatively connected to respective ones of the axles 16. For the sake of clarity, the actuators 25a, 25b are each shown as being operatively and individually connected to just three of the axles 16 in FIG. 2; however, it will be appreciated that each of the axles 16 of the roll screener 12 can be operatively connected to a respective actuator 25a, 25b.

In some embodiments, the actuator 25a can drive the respective axles 16 and attached roll elements 18 at a different rotational speed than the actuator 25b. For instance, the actuator 25b (i.e., the downstream actuator 25b) can drivingly rotate the respective axles 16 and roll elements 18 faster than the actuator 25a (i.e., the upstream actuator 25a); however, it will be appreciated that the axles 16 and roll elements 18 could be rotated at roughly the same speed without departing from the scope of the present disclosure.

Referring back to FIGS. 1 and 2, the screening assembly 10 can further include one or more vibrational screeners 26a, 26b. In the embodiments illustrated, there are two vibrational screeners 26a, 26b ; however, it will be appreciated that the screening assembly 10 could include any suitable number of vibrational screeners 26a, 26b.

Each vibrational screener 26a, 26b can include a respective support structure 28 and a respective vibrating member 30a, 30b. The support structures 28 for the vibrational screeners 26a, 26b can be directly attached and common to both. The support structures 28 can include a plurality of attached rigid beams, plates, or other high-strength members.

Each of the vibrating members 30a, 30b can be a relatively flat, rigid plate with a plurality of respective second openings 32a, 32b formed therein. For instance, the second openings 32a, 32b can be laid out in a grid and spaced in both the X- and Y-directions. The second openings 32a can be slightly larger than the second openings 32b. The vibrating members 30a, 30b can be operatively connected to a vibrating motor (not shown), which can vibrate the members 30a, 30b at any suitable frequency. The vibrating members 30a, 30b can also be supported by one or more springs that facilitate vibration. Also, the vibrating members 30a, 30b can vibrate at different frequencies from each other. Moreover, the frequency of the vibrations can be selected and tailored according to the user's settings in some embodiments. Furthermore, one or both of the vibrating members 30a, 30b can be removably supported by the support structure 28 and replaced by vibrating members 30a, 30b with larger or smaller second openings 32a, 32b such that the size of the second openings 32a, 32b can be selected and tailored for the screening assembly 10.

In some embodiments, the vibrating members 30a, 30b can each be disposed substantially parallel to both the X- and Y-axes, or at least one of the vibrating members 30a, 30b could be disposed at an acute angle relative to the X- and/or Y-axis. Also, the vibrating member 30a can be disposed above and spaced from the vibrating member 30b in the Z-direction (i.e., the direction of gravity). Moreover, the vibrating member 30a can be disposed below the plurality of roll elements 18 of the roll screener 12 (i.e., such that the vibrating member 30a is between the roll elements 18 and the vibrating member 30b) in the Z-direction. Accordingly, the vibrating member 30a can receive materials falling under the force of gravity through the first openings 19 between the roll elements 18, and the vibrating member 30b can receive materials falling under the force of gravity through the second openings 32a.

In additional embodiments, at least one of the vibrating members 30a, 30b can convey materials (e.g., in the X-direction) during vibration. For instance, the vibrating member 30a can convey materials in the X-direction toward a collector 34 while the vibrating member 30b can convey materials toward a collector 36. In other embodiments, the vibrating screeners 26a, 26b can be manually or automatically raked, swept, or otherwise cleaned to move materials into the collectors 34, 36.

During operation, the chopped biomass 11 can be delivered (e.g., by a conveyor belt, etc.) to the upstream end 20 of the roll screener 12. The actuators 25a, 25b can drivingly rotate the axles 16 and roll elements 18. The roll elements 18 can, in turn convey the biomass 11 along the X-direction (the “first direction”), and the outer peripheral surfaces 23 can tumble or otherwise agitate the biomass 11 as it is conveyed. The first openings 19 can be too small to allow passage of the large components 13 of the biomass 11 such that the large components 13 are conveyed in the X-axis direction to be collected in the collector 24. However, the medium-large, medium, and small materials 21, 15, 17 of the biomass 11 can be small enough to pass through the first openings 19 and fall onto the vibrating member 30a due to gravity.

The vibrating member 30a can vibrate to agitate the medium-large, medium, and small components 21, 15, 17 causing separation thereof. Specifically, the second openings 32a can be large enough to allow passage of the medium and small components 15, 17 (i.e., first sub-components) while the medium-large components 21 (i.e., second sub-component) can remain atop the vibrating member 30a. Also, the vibration of the vibrating member 30a can convey the medium-large components 21 into a collector 34. In additional embodiments, the medium-large components 21 can be manually or automatically raked from atop the vibrating member 30a into the collector 34.

Furthermore, the vibrating member 30b can receive the medium and small components 15, 17. As the vibrating member 30 vibrates, the small components 17 (i.e., first sub-sub-components) can move (i.e., fall due to gravity) through the second openings 32b into a collector 38. Meanwhile, the medium components 15 (i.e., second sub-sub-components) can remain atop the vibrating member 30b, or the medium components 15 can be manually or automatically raked or swept into a collector 36.

Biomass material components 13, 15, 17, 21 that are delivered to the collectors 24, 34, 36, 38 can be individually delivered to different downstream stations for further processing or can be individually discarded. For instance, large components 13 can be delivered manually or automatically to a shredder for further size reduction. Medium-large components 21 can also be delivered to a different shredder that is equipped to shred smaller components. The medium components 15 can be small enough to skip shredding, and the medium components 15 can be delivered directly to a chemical treatment station in some embodiments. The small components 17 can be discarded in some embodiments.

Thus, the screening assembly 10 can effectively screen and separate the components 13, 15, 17, 21 of the biomass 11. For instance, the roll screener 12 can effectively tumble and otherwise agitate the biomass 11 while screening the larger components 13 from the rest of the components 15, 17, 21. The roll screener 12 can also screen the biomass 11 at a high throughput speed (e.g., at a minimum of approximately 150 feet/min). The vibrational screeners 26a, 26b can efficiently receive the rest of the components 15, 17, 21 for effective screening.

Also, the screening assembly 10 can be relatively compact (i.e., has a relatively small footprint) because the roll and vibrational screeners 12, 26a, 26b are stacked vertically. Additionally, the screening assembly 10 can operate at a high efficiency because gravity can move one or more of the components 13, 15, 17, 21 through the assembly 10.

Moreover, the screening assembly 10 can be configured and retrofitted relatively easily to screen out materials of different sizes according to the user's desires. For instance, the gaps (the first openings 19) between the roll elements 18 could be such that substantially all material one inch or smaller falls to the vibrational screener 26a. Also, the second openings 32a of the vibrating member 30a could be such that substantially all materials a quarter inch or smaller falls to the vibrating member 30b, and the second openings 32b could be even smaller to screen out finer material components. Moreover, the assembly 10 could include any number of roll screeners 12 or any number of vibrational screeners 26a, 26b to screen and separate any number of components 13, 15, 17, 21 of any relative size.

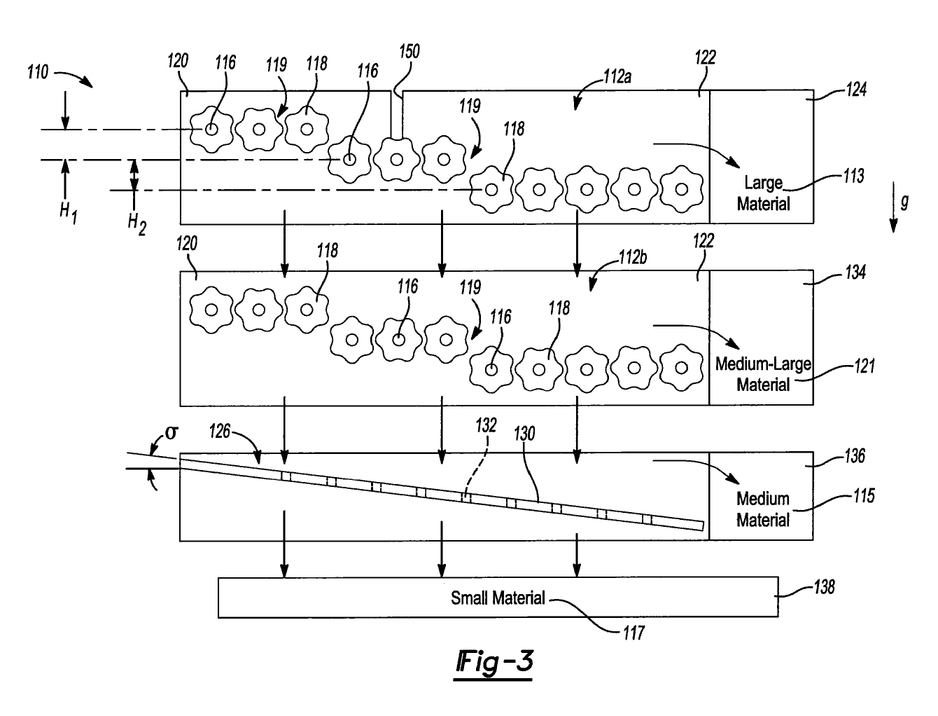

Referring now to FIG. 3, additional exemplary embodiments of the screening assembly 110 are illustrated. Components that are similar to the embodiments of FIGS. 1 and 2 are indicated by similar reference numbers increased by 100.

As shown, the screening assembly 110 can include a plurality (e.g., two) roll screeners 112a, 112b that are stacked vertically in the Z-direction. Also, the axles 116 and roll elements 118 of each roll screener 112a, 112b can be arranged into distinct steps along the X-direction. Specifically, a plurality of axles 116 and roll elements 118 (e.g., three of each) can be disposed at a height H1 above an adjacent group of axles 116 and roll elements 118, and that group of axles 116 and roll elements 118 can be disposed at a height H2 above another adjacent group of axles 116 and roll elements 118. In some embodiments, H1 and H2 can be substantially equal, or the heights H1 and H2 can be different. There can also be any suitable number of steps along the X-direction. Moreover, the heights H1 and H2 can be selectively changed according to the users desires. Thus, in the embodiments shown, the biomass can tumble and fall down the steps while being conveyed generally in the X-direction by the roll elements 118. This additional agitation of the biomass 11 can increase the screening efficiency of the roll screeners 112a, 112b.

As shown, the roll screeners 112a, 112b can include one or more slots 150 that are formed in the support structure and that can receive respective ones of the axles 116. In the illustrated embodiments, the slot 150 is axially straight and oriented vertically. Although only one slot 150 is shown in FIG. 3, it will be appreciated that there can be a plurality of slots 150 that each receive a respective axle 116. Thus, to assemble the roll screeners 112a, 112b, the roll elements 118 can be arranged on respective ones of the axles 116, and the axles 116 can be placed inside (e.g., dropped into) respective slots 150. The axles 116 can be further secured to the support structure with additional fasteners as well (e.g., to limit movement of the axles 116 and roll elements 118 in the vertical direction).

Also, the user can remove and replace one or more axles 116 from the respective slots 150 for reconfiguring the roll screener 112a, 112b. For instance, the axles 116 can be removed from the slots 150, the roll elements 118 can be removed from the axles 116 and replaced with differently sized roll elements 118, and the axles 116 can be repositioned inside the respective slots 150. Likewise, the spacing between roll elements 118 can be changed, and the number of roll elements 118 can be changed. Furthermore, the height H1, H2 of the steps of roll elements 118 can be varied by placing spacers (not shown) inside the slots 150. Moreover, the roll screener 112a, 112b can be operated with less than all of the slots 150 filled to affect the downstream spacing of the adjacent roll elements 118 and axles 116.

Furthermore, as shown in FIG. 3, the vibrating member 130 can be disposed at an acute angle a relative to the X-axis. Accordingly, materials atop the vibrating member 130 can slide downward due to gravity and convey across the vibrating member 130 as the vibrating member 130 vibrates.

Thus, like the embodiments of FIGS. 1 and 2, the screening assembly 110 can efficiently and effectively screen biomass 11 or other materials. Also, the screening assembly 110 can be relatively compact. Moreover, the screening assembly 110 can be conveniently configured and retrofitted according to the user's desires.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A screening assembly for separating components of a material, the screening assembly comprising:
at least one roll screener with a plurality of roll elements that are spaced apart from each other generally in a first direction to define a plurality of first openings therebetween, the roll elements operable to rotate to separate the material into a first component and second component, the first component being conveyed generally in the first direction, and the second component moving away from the first component through the first openings; and
at least one vibrational screener with a vibrating member that defines a plurality of second openings, the vibrating member operable to receive the second component and to vibrate to separate the second component into a first sub-component and a second sub-component, the second sub-component moving away from the first sub-component through the second openings.

2. The screening assembly of claim 1, wherein the at least one roll screener is disposed over the vibrating member such that the vibrating member is operable to receive the second component falling through the first openings due to gravity.

3. The screening assembly of claim 1, wherein the plurality of roll elements are also spaced apart from each other in a second direction that is transverse to the first direction to define the first openings.

4. The screening assembly of claim 3, wherein the at least one roll screener also includes a roll support structure and a plurality of axles that are rotatably supported by the roll support structure, each of the plurality of axles supporting respective ones of the plurality of roll elements that are spaced apart from each other in the second direction, the plurality of axles spaced away from each other in the first direction.

5. The screening assembly of claim 4, wherein the plurality of roll elements and the plurality of axles are arranged to define a plurality of roll steps along the first direction, the plurality of roll steps being spaced apart in a third direction that is transverse to the first direction and the second direction.

6. The screening assembly of claim 1, wherein the plurality of first openings have substantially equal sizes.

7. The screening assembly of claim 1, wherein at least one of the plurality of roll elements is a disc with an outer peripheral surface that is operable to rotate about an axis of rotation, the outer peripheral surface varying in a radial distance from the axis of rotation.

8. The screening assembly of claim 1, wherein each of the plurality of roll elements of the at least one roll screener are substantially equal in size.

9. The screening assembly of claim 1, further comprising a first actuator that is operable to drivingly rotate at least one of the plurality of rolling elements at a first speed, and a second actuator that operable to drivingly rotate another of the plurality of rolling elements at a second speed, the second speed being different from the first speed.

10. The screening assembly of claim 9, wherein the plurality of roll elements includes an upstream roll element and a downstream roll element, the upstream roll element and the downstream roll element being separated in the first direction, wherein the first actuator is operable to drivingly rotate the upstream roll element at the first speed, wherein the second actuator is operable to drivingly rotate the downstream roll element at the second speed, the second speed being greater than the first speed.

11. The screening assembly of claim 1, wherein the at least one roll screener includes a first roll screener and a second roll screener, the second roll screener being disposed between the first roll screener and the at least one vibrational screener.

12. The screening assembly of claim 1, wherein the at least one vibrational screener includes a first vibrational screener and a second vibrational screener, the first vibrational screener being disposed between the at least one roll screener and the second vibrational screener.

13. The screening assembly of claim 1, wherein the screening assembly defines a third direction that is substantially parallel to a direction of gravity, and wherein the vibrating member is disposed at an acute angle relative to the third direction.

14. A screening assembly for separating components of a material, the screening assembly comprising:
a first roll screener with a plurality of roll elements that are spaced apart from each other generally in a first direction to define a plurality of first openings therebetween, the roll elements operable to rotate to separate the material into a first component and second component, the first component being conveyed generally in the first direction, and the second component moving away from the first component through the first openings; and
a secondary screener that defines a plurality of second openings, the secondary screener being disposed underneath the first openings such that the secondary screener is operable to receive the second component falling through the first openings due to gravity, the secondary screener operable to receive the second component and to separate the second component into a first sub-component and a second sub-component, the second sub-component moving away from the first sub-component through the second openings.

15. The screening assembly of claim 14, wherein the secondary screener is a vibrational screener with a vibrating member that defines the plurality of second openings, the vibrating member operable to receive the second component and to vibrate to separate the second component into the first sub-component and the second sub-component, the second sub-component moving away from the first sub-component through the second openings.

16. The screening assembly of claim 14, wherein the secondary screener is a secondary roll screener with a plurality of secondary roll elements that are spaced apart from each other to define the plurality of second openings therebetween, the secondary roll elements operable to receive the second component and to rotate to separate the second component into the first sub-component and the second sub-component, the second sub-component moving away from the first sub-component through the second openings.

17. The screening assembly of claim 14, wherein the plurality of roll elements are arranged to define a plurality of roll steps along the first direction.

18. The screening assembly of claim 14, wherein the plurality of first openings have substantially equal sizes.

19. The screening assembly of claim 14, wherein at least one of the plurality of roll elements is a disc with an outer peripheral surface that is operable to rotate about an axis of rotation, the outer peripheral surface varying in a radial distance from the axis of rotation.

20. The screening assembly of claim 14, further comprising a first actuator that is operable to drivingly rotate at least one of the plurality of rolling elements at a first speed, and a second actuator that operable to drivingly rotate another of the plurality of rolling elements at a second speed, the second speed being different from the first speed.
